(19) United States
(12) Patent Application Publication
(10) Pub. No.: US 2007/0170970 A1
(43) Pub. Date: Jul. 26, 2007

(54) SEMICONDUCTOR DEVICE AND DATA INPUT/OUTPUT SYSTEM

(75) Inventor: Toshio ISONO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/625,654

(22) Filed: Jan. 22, 2007

(30) Foreign Application Priority Data
Jan. 23, 2006 (JP) 2006-013831

(51) Int. Cl. G06F 1/04

(52) U.S. Cl. 327/295

(57) ABSTRACT

There is provided a semiconductor device that operates at an internal clock based on a system clock and inputs/outputs data in synchronization with the internal clock. The semiconductor device includes a phase locked loop generating the internal clock and a switching element switching delay paths to be inserted into a feedback loop to the phase locked loop in accordance with data input/output in the semiconductor device.

### BACKGROUND OF THE INVENTION

1. Field of the Invention

The present invention relates to a semiconductor device and a data input/output system using the semiconductor device and, particularly, to a system for inputting and outputting data based on a system clock.

2. Description of Related Art

In a system where a plurality of semiconductor devices are mounted, a signal for synchronizing the entire system, which is called a system clock, is distributed to each semiconductor device. Each semiconductor device operates in synchronization with the system clock, so that the system as a whole operates at the same timing. When transferring data between the semiconductor devices within the system, clock skew between a semiconductor device at the transmitting end and a semiconductor device at the receiving end or a transmission time to transfer data from an output buffer of the semiconductor device at the transmitting end through a line on a printed circuit system board to an input buffer of the semiconductor device at the receiving end vary by external factors such as power supply voltage and temperature. Therefore, it is necessary for the semiconductor device at the receiving end to retain a wide set up margin and hold margin, which hampers the high-speed system clock operation.

FIG. 5 shows the configuration of such a system. FIG. 5 illustrates a system which synchronizes semiconductor devices using a phase locked loop, which is abbreviated to PLL. In FIG. 5, a system clock is supplied to a transmitting-end semiconductor device 1 through an input terminal 132. The system clock is input to a reference input point b1 of a PLL 141 through an input buffer 102. The clock output from the PLL 141 is then supplied to a clock distribution tree 171. The clock distribution tree 171 is composed of a plurality of CTS buffers 172 and clock distribution lines. Through the clock distribution tree 171, the clock with minimal skew is supplied to flip-flops 151 and 152.

The output b2 of the clock distribution tree 171 is supplied as a feedback clock to the feedback input of the PLL 141 through an input buffer 103. The input buffer 103 is inserted in order to add to the feedback path the same delay time as that of the input buffer 102 at the reference input side of the PLL 141. Thus, it may be simply a delay circuit as long as it has the same delay characteristics as the input buffer 102.

A system clock is supplied also to a receiving-end semiconductor device 2 through an input terminal 232. The system clock is supplied to flip-flops 251 and 252 or the like through an input buffer 202, a PLL 241, and a clock distribution tree 271. The configuration of the receiving-end semiconductor device 2 is basically the same as that of the transmitting-end semiconductor device 1 and it is thus not described in detail herein.

The data transfer between the semiconductor devices in such a system is described hereinbelow. In the transmitting-end semiconductor device 1, external data is input through a data input terminal 131 and supplied to the flip-flop 151 through the input buffer 101. The flip-flop 151 latches the data based on the clock at the point b2. The input data is processed in a logic circuit 161 and the processing result is stored in the flip-flop 152. The processing result data is output from the flip-flop 152 through an output buffer 111. The output data is latched into the flip-flop 251 of the receiving-end semiconductor device 2 through an output terminal 133 of the semiconductor device 1, a line between the semiconductor devices (e.g. a line of the printed circuit board) 300, an input terminal 231 and an input buffer 201 of the semiconductor device 2.

In the receiving-end semiconductor device 2, the flip-flop 251 latches the data based on the clock at the output point c2 of the clock distribution tree 271 in the same manner as in the transmitting-end semiconductor device 1. The data is thereby transferred from the semiconductor device 1 to the semiconductor device 2.

FIG. 6 shows a timing chart based on the above-described operation. In the transmitting-end semiconductor device 1, the phase of the reference CLK input b1 of the PLL 141 delays to the phase of the system clock a by the delay of tpd1I through the input buffer 102. On the other hand, the phase of the output b2 of the clock distribution tree 171 advances to the phase of b1 by the delay through the input buffer 103. The phase at the data output terminal point b3 further delays to the phase of b2 by the delay of tpd1O through the output buffer 111 as shown in FIG. 6.

In the receiving-end semiconductor device 2, if the delay through the line 300 is tpd3O and the delay through the input buffer 201 is tpd2I, the phase of the data input c3 to the flip-flop 251 delays to the phase of b3 by the delay of tpd3O+tpd2I. On the other hand, the phase of the PLL reference CLK input c1 delays to the system clock a by the delay of tpd2I through the input buffer 202.

In the system with such a configuration, if the setup margin and the hold margin of the flip-flop 251 are referred respectively as tSetup (a time from a change of the input data to the flip-flop to a clock edge) and tHold (a time to retain the state value of input data from a clock edge of clock input to the flip-flop), the system clock cycle T is represented as Expression 2 below. Upon consideration of the delay tpd1O through the transmitting-end output buffer 111, the delay tpd3O through the line 300, the delay tpd2I through the receiving-end input buffer 201, and the setup margin tSetup, the system clock cycle T is represented as Expression 1 below. For simplification, the present description defines the setup margin tSetup and the hold margin tHold assuming that the setup time and hold time of the flip-flop are both 0. In these conditions, the following expressions are given:

T=tpd1O+tpd3O+tpd2I+tSetup Expression 1:

T=tSetup+tHold. Expression 2:

Expression 1 can be rewritten as:

tSetup=T−(tpd2I+tpd1O+tpd3O). Expression 3:

From Expressions 2 and 3, the following expression is given:

tHold=tpd2I+tpd1O+tpd3O. Expression 4:

The delay of the output buffer, the delay of the input buffer or the like varies by external factors such as power supply voltage and temperature. Thus, the setup margin tSetup and the hold margin tHold should be wide enough to absorb the variation. It is therefore difficult to shorten the cycle T.

The technique disclosed in Japanese Unexamined Patent Application Publication No. 2000-347764 (Nomura et al.) addresses this drawback. FIG. 7 shows the system taught by Nomura et al. In FIG. 7, the same elements as in FIG. 5 are denoted by the same reference symbols and redundant description is omitted. In the semiconductor devices 1 and 2 shown in FIG. 7, the outputs b2 and c2 of the clock distribution trees 171 and 271 are supplied as feedback clocks to the feedback inputs of the PLLs 141 and 241 through the input buffers 103, 203 and the output buffers 113, 213, respectively. The semiconductor devices of FIG. 7 are different from the semiconductor devices of FIG. 5 in that the output buffers 113 and 213 are added to the clock feedback paths to the PLLs 141 and 241.

According to the technique taught by Nomura et al., such a configuration is not affected by the delay through the output buffer 111 of the transmitting-end semiconductor device 1. FIG. 8 shows the timing chart of the device described in Nomura et al. In consideration of the delay tpd2O through the output buffer 213 which is inserted to the feedback path at the receiving end, the setup margin and the hold margin in the system according to Nomura et al. are expressed as follows:

tSetup=T−(tpd2O+tpd2I+tpd3O) Expression 5:

tHold=tpd2O+tpd2I+tpd3O. Expression 6:

In the technique disclosed in Nomura et al., however, the setup margin tSetup and the hold margin tHold vary by the external factor of the output buffer delay at the receiving end as is obvious from the fact that Expressions 5 and 6 contain the delay tpd2O through the output buffer of the receiving-end semiconductor device 2. Accordingly, even with the configuration as taught by Nomura et al., it is still difficult to shorten the system clock cycle T to achieve high-speed operation due to the effects of external factors.

### SUMMARY OF THE INVENTION

According to one aspect of the present invention, there is provided a semiconductor device that operates at an internal clock based on a system clock and inputs/outputs data in synchronization with the internal clock, including a phase locked loop generating the internal clock, and a switching element switching delay paths to be inserted into a feedback loop to the phase locked loop in accordance with data input/output in the semiconductor device.

According to another aspect of the present invention, there is provided a data input/output system including a first semiconductor device outputting data in synchronization with a first internal clock based on a system clock, and a second semiconductor device inputting data in synchronization with a second internal clock based on a system clock, wherein the first internal clock advances to the second internal clock by a phase corresponding to an output buffer delay in the first semiconductor device.

This configuration prevents a setup margin and hold margin from being affected by output buffer delay in the semiconductor device. Furthermore, the configuration allows the reduction of a setup margin to thereby enable the system to operate at a higher speed.

### BRIEF DESCRIPTION OF THE DRAWINGS

The above and other objects, advantages and features of the present invention will be more apparent from the following description taken in conjunction with the accompanying drawings, in which:

FIG. 1 is a view showing the configuration according to a first embodiment of the present invention;

FIG. 2 is a timing chart showing the operation according to the first embodiment;

FIG. 3 is a view showing the configuration according to a second embodiment of the present invention;

FIG. 4 is a view showing the configuration according to a third embodiment of the present invention;

FIG. 5 is a view showing the configuration according to a related art;

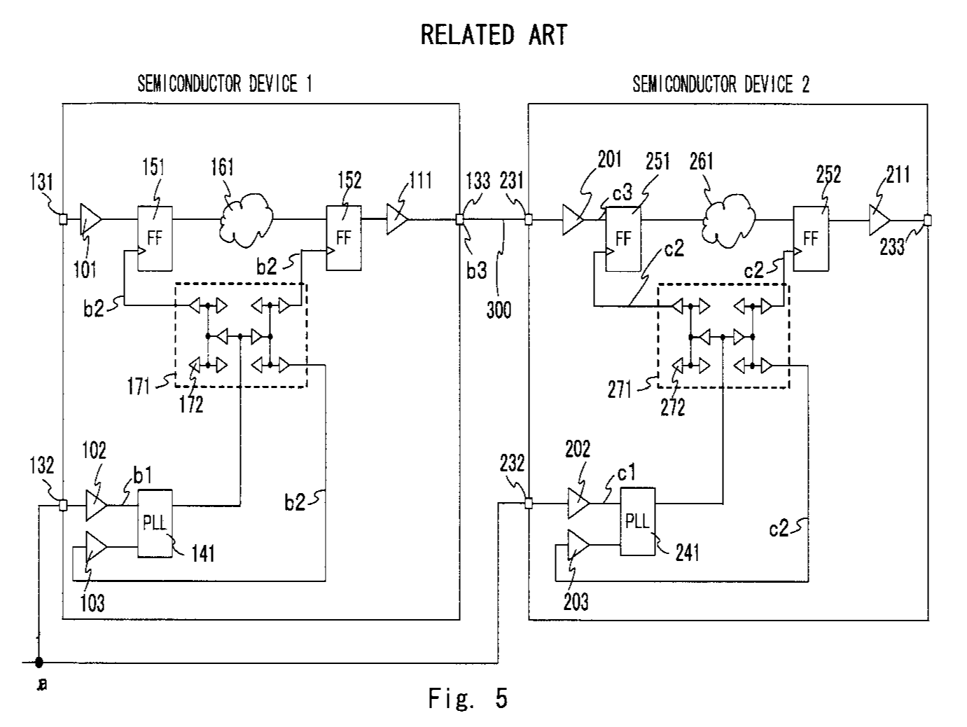

FIG. 6 is a timing chart to describe the operation according to a related art;

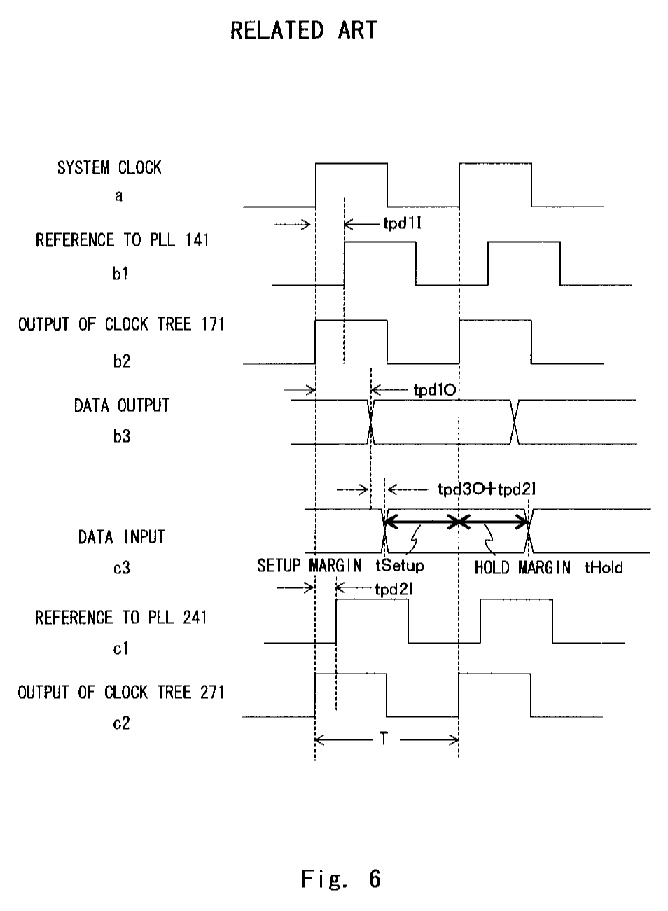

FIG. 7 is a view showing the configuration according to a related art; and

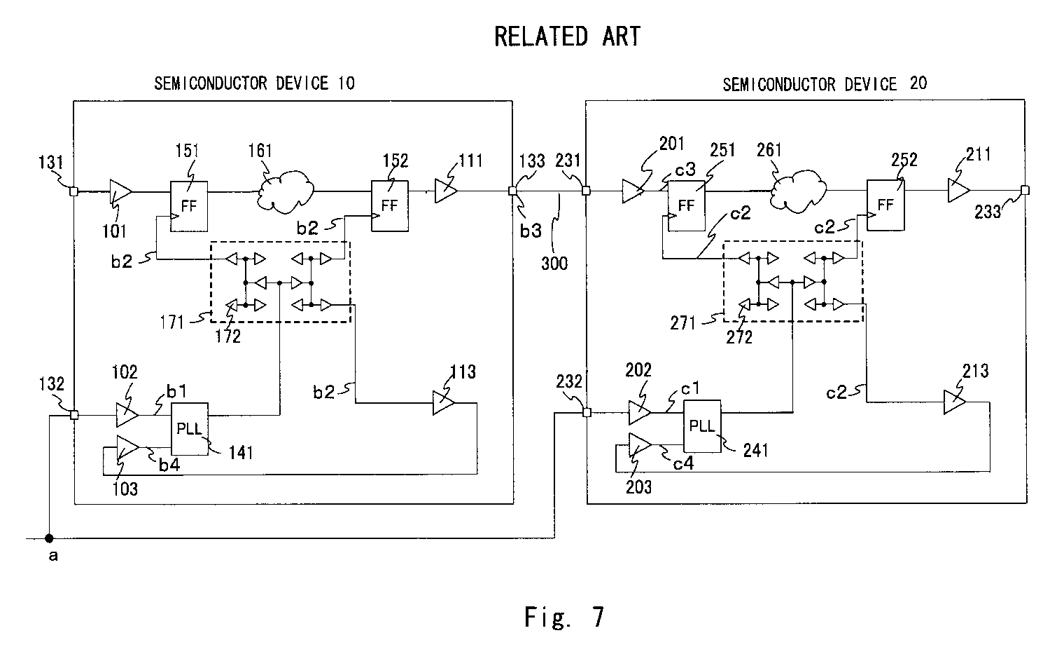

FIG. 8 is a timing chart to describe the operation according to a related art.

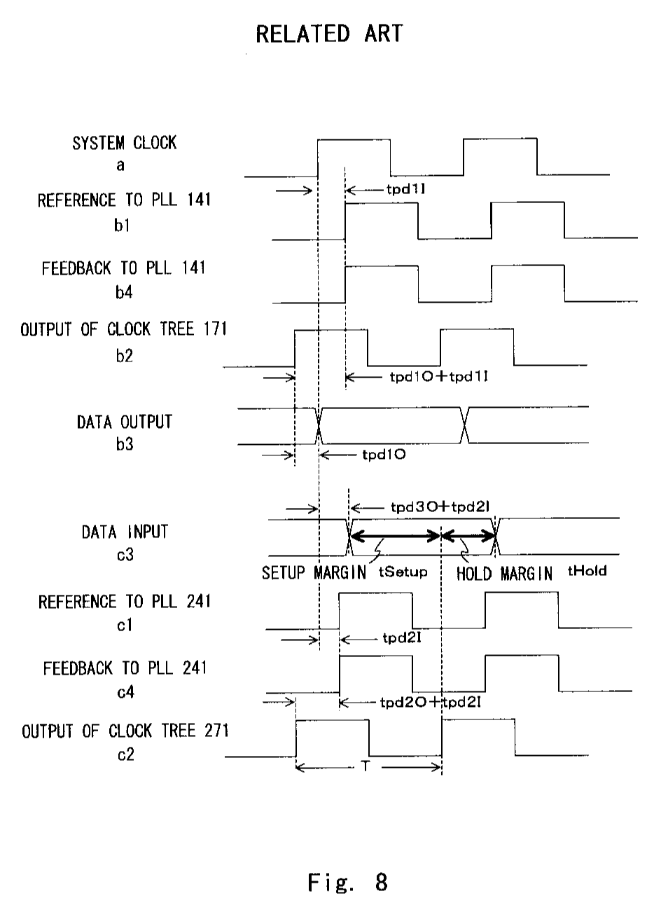

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

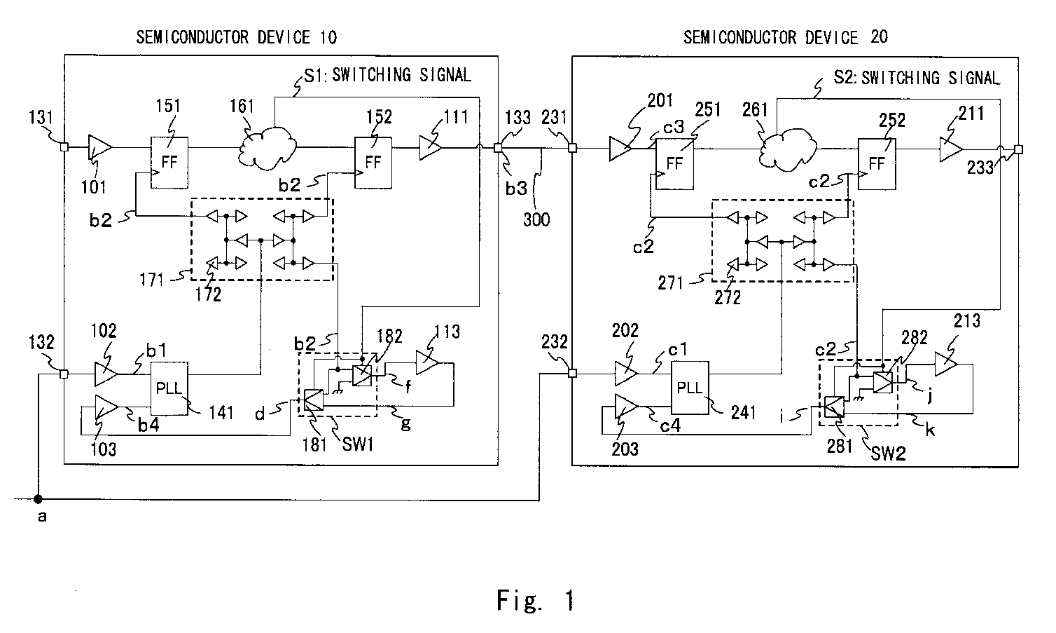

FIG. 1 is a block diagram showing the system according to a first embodiment of the present invention. A first embodiment is described with reference to a system which includes a plurality of semiconductor devices that are mounted on a mother board or the like and operate in synchronization with the system clock of the mother board. The system of this embodiment includes a transmitting-end semiconductor device 10 and a receiving-end semiconductor device 20. The transmitting-end semiconductor device 10 and the receiving-end semiconductor device 20 are connected through a line 300 on a printed circuit board, for example. The transmitting-end semiconductor device 10 and the receiving-end semiconductor device 20 include PLL 141 and 241, clock distribution trees 171 and 271, flip-flops 151, 152 and 251, 252, logic circuits 161 and 261, input buffers 101 to 103 and 201 to 203, output buffers 111, 113 and 211, 213, and switches SW1 and SW2, respectively.

The semiconductor device which is mounted on the system according to this embodiment is described hereinafter with reference to the transmitting-end semiconductor device 10 as an example. In this embodiment, the system clock which is input through the point a shown in FIG. 1 is input as a reference clock to the PLL 141 through the input terminal 132 and the input buffer 102. The PLL 141 outputs an internal clock based on the reference clock to the clock distribution tree 171. The clock distribution tree 171 distributes the clock to the flip-flops 151 and 152 or the like in the semiconductor device 10 through the CTS buffers 172 and the clock distribution lines. The output b2 of the clock distribution tree 171 is input as a feedback clock to the PLL 141 through the switch SW1, the output buffer 113 and the input buffer 103.

The output buffer 113 and the input buffer 103 which are inserted to the feedback path may be simply configured as delay circuits as long as they have the same delay characteristics as the output buffer 111 which outputs data and the input buffers 101 and 102 which receive system clocks in the semiconductor device 10.

The switch SW1 includes selectors 181 and 182 to select whether to supply the output of the clock distribution tree 171 to the input buffer 103 either directly or through the output buffer 113 according to a feedback path switching signal S1, which is described later. Specifically, the switch SW1 outputs the output b2 of the clock distribution tree 171 either through the point d or through the point f depending on the feedback path switching signal. When supplying the output b2 of the clock distribution tree 171 directly to the point d, the selector 182 selects the ground voltage to thereby stop the operation of the output buffer 113.

Data to be processed in the semiconductor device 10 is latched into the flip-flop 151 through the data input terminal 131 and the input buffer 101. After being processed in the logic circuit 161, the data is latched into the flip-flop 152. The latched data is then output through the output buffer 111 and the output terminal 133. In accordance with its operation, the logic circuit 161 outputs the feedback path switching signal S1 described above. In this embodiment, during the transmitting operation (output), the output b2 of the clock distribution tree 171 is input to the input buffer 103 through the output buffer 113 by connecting the point b2 to the point f. During the receiving operation (input), the output of the clock distribution tree 171 is input to the input buffer 103 directly by connecting the point b2 to the point d.

The receiving-end semiconductor device 20 has basically the same configuration as the transmitting-end semiconductor device 10 and it is thus not described in detail herein.

In the data transfer from the transmitting-end semiconductor device 10 to the receiving-end semiconductor device 20, data is latched into the flip-flop 151 in synchronization with the clock at the output b2 of the clock distribution tree 171. The latched data is processed in the logic circuit 161 and then latched into the flip-flop 152 in synchronization with the clock at b2. After that, the data is output through the output buffer 111 and the output terminal 133. The data output from the semiconductor device 10 is then latched into the flip-flop 251 of the semiconductor device 20 through the line 300 between the semiconductor devices and the input terminal 232 and the input buffer 201 of the semiconductor device 20.

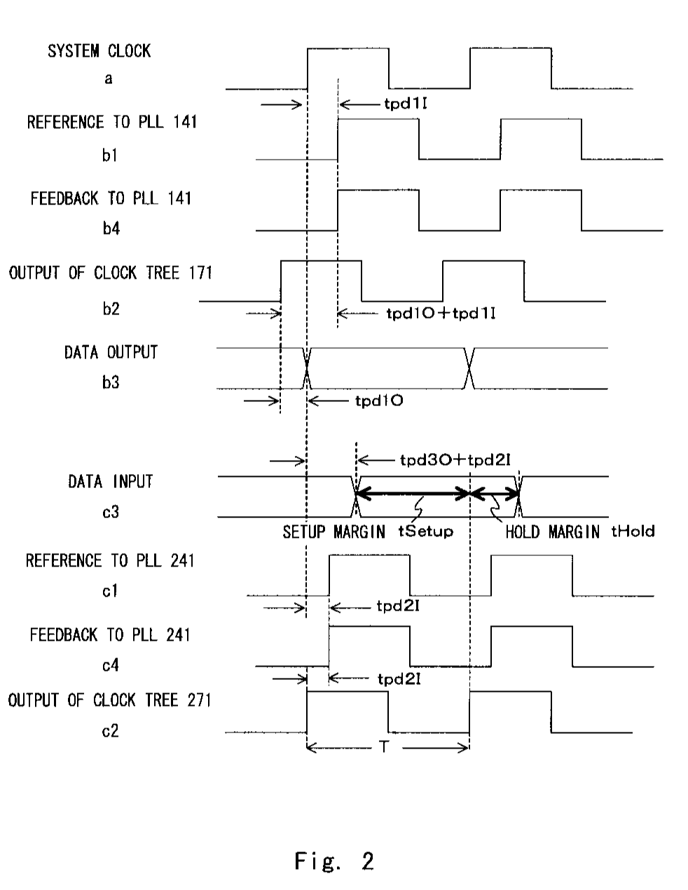

FIG. 2 is a timing chart showing the timing of the series of operations described above. The above-described operations are described hereinafter in detail with reference to FIGS. 1 and 2.

When a system clock as shown at the top of FIG. 2 is supplied to the point a in FIG. 1, the phase of the reference clock which is input to the PLL 141 at the point b1 in the semiconductor device 10 delays by the delay of tpd1I due to the input buffer 102. The phase of the feedback input b4 to the PLL 141 is aligned with the phase of the input b1 by the PLL 141 and therefore it is the same as the phase of the input b1.

Because the semiconductor device 10 is at the transmitting end, the switch SW1 selects the path to feedback through the output buffer 113 and the input buffer 103. Thus, the phase of b2 advances to the phase of b4 by the delay of tpd1O through the output buffer 113 and the delay of tpd1I through the input buffer 103. On the other hand, the phase of data at b3 which is output from the semiconductor device 10 delays to the clock at b2 by the delay of tpd1O through the output buffer 111. Accordingly, the data with the phase aligned with the phase of the system clock (a) is output at b3 from the semiconductor device 10 as shown in FIG. 2.

On the other hand, the data at c3 which is input to the flip-flop 251 of the semiconductor device 20 changes from the data change at b3 by the delay tpd3O through the line 300 and the delay through the input buffer 201 as illustrated in the sixth waveform in FIG. 2. Because the semiconductor device 20 is supplied with the same system clock as that for the semiconductor device 10, the reference clock input c1 to the PLL 241 has the phase difference corresponding to the delay tpd2I of the input buffer 202 with respect to the point a. The phase of the feedback input c4 to the PLL 241 is aligned with the phase of the input c1 by the PLL 241 and therefore the inputs c1 and c4 have the same phase.

Because the semiconductor device 20 is at the receiving end, the switch SW2 selects the path to feedback without through the output buffer 213. The output c2 of the clock distribution line is thus supplied directly to the input buffer 203 by connecting the point c2 to the point i.

Accordingly, the phase at the point c2 advances to the phase at the point c4 by the delay of tpd2I due to the input buffer 203. The cycle T of the system clock is determined by the following expressions in consideration of the delay tpd3O through the line and the delay through the input buffer 201:

T=tpd3O+tpd2I+tSetup Expression 7:

T=tSetup+tHold Expression 8:

From Expressions 7 and 8, the setup margin tSetup and the hold margin tHold can be calculated as follows:

tSetup=T−(tpd3O+tpd2I) Expression 11:

tHold=tpd3O+tpd2I Expression 12:

As obvious from the above expressions, neither of the expressions representing the setup margin and the hold margin includes the term indicating the delay through the output buffer of the semiconductor 10 or 20 according to this embodiment.

In the related art, if the delay tpd1O and tpd2O are 3 ns (typ), they vary in the range from 1.5 ns to 4.5 ns under the conditions of a power supply voltage of +/−10% and a temperature of −40° C. to 125=C. The timing margins of tSetup and tHold decrease by the variation range of 3 ns, and it is thus difficult to shorten the cycle T.

Because the term indicating the output buffer is not included in any expressions according to this embodiment, the cycle T can be set shorter by the variation range of 3 ns. It is thereby possible to set the system clock to a higher frequency to thereby achieve higher-speed operation.

Furthermore, according to this embodiment, the clock edge of the clock which is output from the clock distribution tree 171 in the transmitting-end semiconductor device 10 is set earlier than the clock edge of the clock which is output from the clock distribution tree 271 in the receiving-end semiconductor device 20, thereby increasing the timing margin.

### Second Embodiment

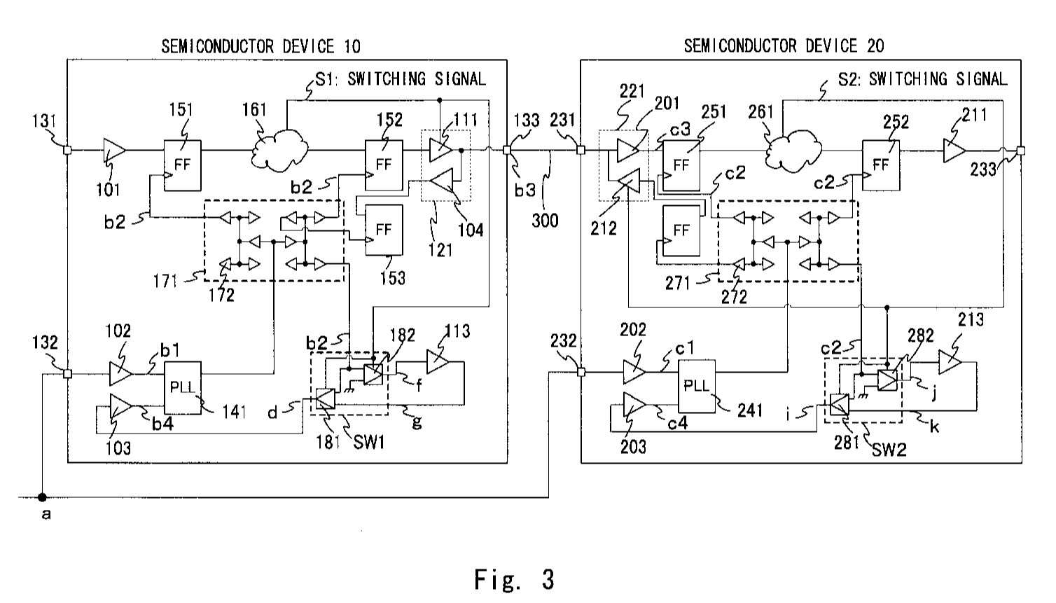

FIG. 3 is a view showing the configuration according to a second embodiment of the present invention. In FIG. 3, the same elements as in FIG. 1 are denoted by the same reference symbols and not described in detail herein. The second embodiment is different from the first embodiment in that the semiconductor device 10 and the semiconductor device 20 transfer data with each other. In this system, the output buffer 111 of the semiconductor device 10 is replaced by a bidirectional buffer 121, and the input buffer 201 of the semiconductor device 20 is replaced by a bidirectional buffer 221. The bidirectional buffer 121 is composed of the output buffer 111 and an input buffer 104, and the bidirectional buffer 221 is composed of the output buffer 212 and an input buffer 201. The output buffer 111 incurs the delay of tpd1O, the input buffer 104 incurs tpd1I, the output buffer 212 incurs tpd2O, and the input buffer 201 incurs tpd2I.

In such a configuration, the semiconductor devices 10 and 20 select the feedback path through the output buffer 113 and 213, respectively, when transmitting data and select the feedback path not through the output buffer 113 or 213 when receiving data as described earlier.

Further, based on the feedback path switching signals S1 and S2 for selecting the feedback path, the output buffer of the bidirectional buffer is set to ENABLE or DISABLE state. The system is in output mode when the output buffer of the bidirectional buffer is ENABLE state; the system is in input mode when the output buffer is DISABLE state.

For example, in the semiconductor device 10, the output buffer 111 is ENABLE state (and the output buffer 212 of the bidirectional buffer 221 is DISABLE state) when the bidirectional buffer 121 transmits data to the semiconductor device 20. On the other hand, the output buffer 111 is DISABLE state (and the output buffer 212 of the bidirectional buffer 221 is ENABLE state) when the bidirectional buffer 121 receives data from the semiconductor device 20. The states (ENABLE/DISABLE) of the bidirectional buffers 121 and 221 are set opposite to each other in this manner.

Such a configuration achieves the high-speed operation of the system as in the first embodiment and further enables the intercommunication between the semiconductor devices. Although FIG. 3 illustrates the case where only the output buffer 111 of the semiconductor device 10 and the input buffer 201 of the semiconductor device 20 are configured as bidirectional buffers, the input buffer 101 of the semiconductor device 10 and the output buffer 211 of the semiconductor device 20 may also be configured as bidirectional buffers.

### Third Embodiment

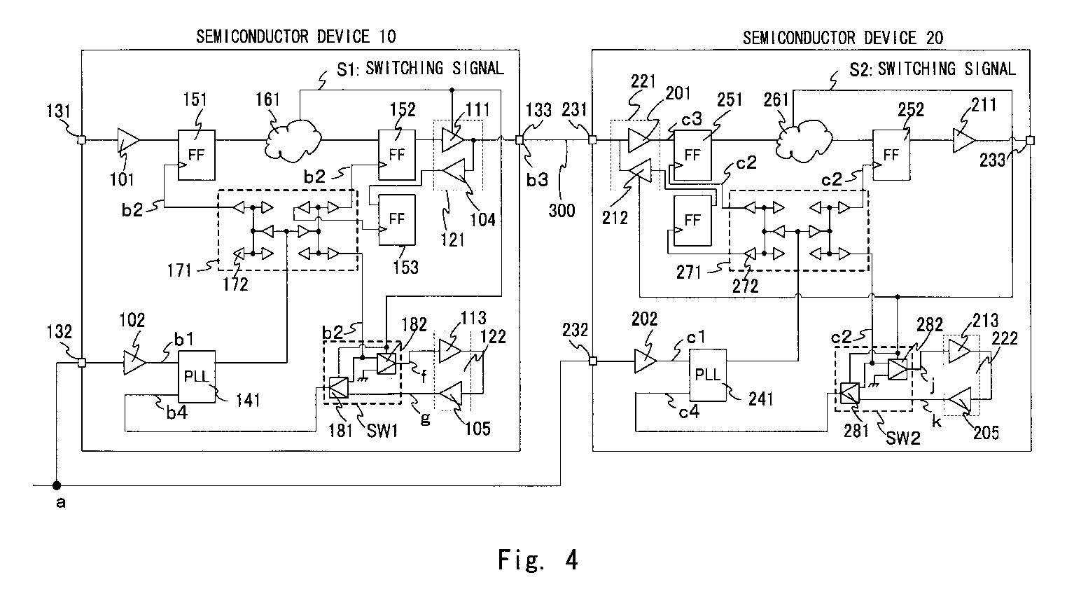

FIG. 4 is a circuit diagram showing the configuration according to a third embodiment of the present invention. As described in the second embodiment, if data input and output are performed using bidirectional buffers, each bidirectional buffer includes an input buffer and an output buffer. Thus, it is possible to replace the output buffers 113 (213) and 103 (203) which are included in the feedback path in the second embodiment by bidirectional buffers that are identical to those used for data input and output. The use of the identical bidirectional buffers allows the delay characteristics in the feedback path to be substantially the same as the delay characteristics in the data input/output, which enables the reduction of timing mismatch with a simple configuration. In such a case, an input buffer 107 which incurs the delay time corresponding to that of the input buffer 103 (i.e. tpd1I) in FIG. 3, and an input buffer 207 which incurs the delay time corresponding to that of the input buffer 203 (i.e. tpd2I) in FIG. 3 are inserted between the selector 181 and the point b2 and between the selector 281 and the point c2, respectively. The input buffer 107 and the input buffer 207 may be simply a buffer or a delay circuit as long as the delay time is a desired value as described above.

As described above, the present invention prevents the setup margin and the hold margin from being affected by the delay through the output buffer in the semiconductor device. This allows the reduction of a setup margin to thereby enable the system to operate at a higher speed.

It is apparent that the present invention is not limited to the above embodiment and it may be modified and changed without departing from the scope and spirit of the invention.

What is claimed is:

1. A semiconductor device that operates at an internal clock based on a system clock and inputs/outputs data in synchronization with the internal clock, comprising:
a phase locked loop generating the internal clock; and
a switching element switching delay paths to be inserted into a feedback loop to the phase locked loop in accordance with data input/output in the semiconductor device.

2. The semiconductor device according to claim 1, wherein
a delay path corresponding to a delay through an output buffer to output data and through an input buffer to receive the system clock is selected when outputting data, and a delay path corresponding to a delay through the input buffer is selected when inputting data.

3. The semiconductor device according to claim 1, comprising:
a bidirectional buffer inputting and outputting the data.

4. The semiconductor device according to claim 2, comprising:
a bidirectional buffer inputting and outputting the data.

5. The semiconductor device according to claim 3, wherein
the delay path includes a buffer identical to the bidirectional buffer inputting and outputting the data.

6. The semiconductor device according to claim 4, wherein
the delay path includes a buffer identical to the bidirectional buffer inputting and outputting the data.

7. A data input/output system comprising:
a first semiconductor device outputting data in synchronization with a first internal clock based on a system clock; and
a second semiconductor device inputting data in synchronization with a second internal clock based on the system clock,
wherein the first internal clock advances to the second internal clock by a phase corresponding to an output buffer delay in the first semiconductor device.

8. The data input/output system according to claim 7, wherein
the first semiconductor device includes a first phase locked loop generating the first internal clock from the system clock and the first internal clock fed hack with a first delay, and
the second semiconductor device includes a second phase locked loop generating the second internal clock from the system clock and the second internal clock fed back with a second delay.

9. The data input/output system according to claim 8, wherein
the first delay corresponds to a delay through a data output buffer of the first semiconductor device and through a system clock input buffer, and
the second delay corresponds to a delay through a system clock input buffer of the second semiconductor device.
